(19) United States
(12) Patent Application Publication
(10) Pub. No.: US 2024/0198259 A1
(43) Pub. Date: Jun. 20, 2024

(54) FILTER SYSTEM WITH CANISTER MOVEMENT APPRATUS

(71) Applicant: John Crane UK Limited, Slough (GB)

(72) Inventors: Thomas Grimm-Bosbach, Vellmar (DE); Marco Vent, Schauenburg Hessen (DE)

(21) Appl. No.: 18/541,866

(22) Filed: Dec. 15, 2023

Related U.S. Application Data
(60) Provisional application No. 63/432,887, filed on Dec. 15, 2022.

(51) Int. Cl. B01D 29/96; B01D 29/52; B01D 35/18

(52) U.S. Cl. CPC B01D 29/96; B01D 29/52; B01D 35/18

(57) ABSTRACT

A filter system includes a duplex filter system that includes a first housing and a second housing configured to filter a liquid, a heating housing arranged adjacent the duplex filter system; a lifting system arranged to move filter canisters from the heating housing to one of the first or second housing.

### CROSS REFERENCE TO RELATED APPLICATION

This application claims the benefit of an earlier filing date from U.S. Provisional Application Ser. No. 63/432,887 filed Dec. 15, 2022, the entire disclosures of both which are incorporated herein by reference.

### BACKGROUND

Exemplary embodiments of the present disclosure pertain to the art of systems and methods for managing the cleaning and rotation of filter media in a filtering system.

For use in the polymer industry in applications where there is a continuous process from feedstock to final product such that new filter media is seamlessly ‘switched in’ to replace expended media. These systems are often described as duplex filtration systems.

Duplex filtration systems are characterized by two identical sets of filtration media. Each filtration media is in its own vessel and is connected to the process flow through a switching mechanism to alternate between inline and standby positions. Once “switched out.” the expended filtration media is replaced, usually by recovered (cleaned) media. In addition, the inside of the vessel may also be cleaned.

Some polymer companies invest in in-house facilities to better control the cleaning cycle (and reduce costs). The other benefit of this is reduced time taken to clean the vessel and recover the filter media, which can be substantial if the filter media must be sent to an external cleaning service.

The filter media recovery process has been operating in these ways for many years. When used with virgin polymers, it is possible for the inline filter media to require switching only after multiple months of ‘onstream life.”

### SUMMARY

The inventors hereof have discovered that with the rise of either partially or 100% recycled feedstock, the onstream life of filtration media is reduced. In some cases, the reduction is such that the time between 100% recovered media at “switch in” and 100% expended media at “switch out” can be less than time required to perform the filter media recovery process.

The disclosed system more fully described below may be able to speed up filter media removal and new filter media inclusion to increase confidence in process continuity.

The disclosed system more fully described below may be able to enable extensive cleaning of filter vessel and any downstream piping in addition to filter media for improved product purity and so reduced process contamination.

The disclosed system more fully described below may be able simplify and structure the process to increase process consistency and safety (with the option to automate).

The disclosed system more fully described below may be able to reduce the time pressure on the cleaning process with an additional vessel and its preheating station.

### BRIEF DESCRIPTION OF THE DRAWINGS

The following descriptions should not be considered limiting in any way. With reference to the accompanying drawings, like elements are numbered alike:

FIG. 1 illustrates a system that can used to load and unload filter media and that includes three vessels and a lift system arranged relative to them according to one embodiment;

FIG. 2 illustrates a system that can used to load and unload filter media and that includes three vessels and a lift system arranged relative to them according to another embodiment; and

FIG. 3 illustrates a system that can used to load and unload filter media and that includes three vessels and a lift system arranged relative to them according to yet another embodiment.

### DETAILED DESCRIPTION

A detailed description of one or more embodiments of the disclosed apparatus and method are presented herein by way of exemplification and not limitation with reference to the Figures.

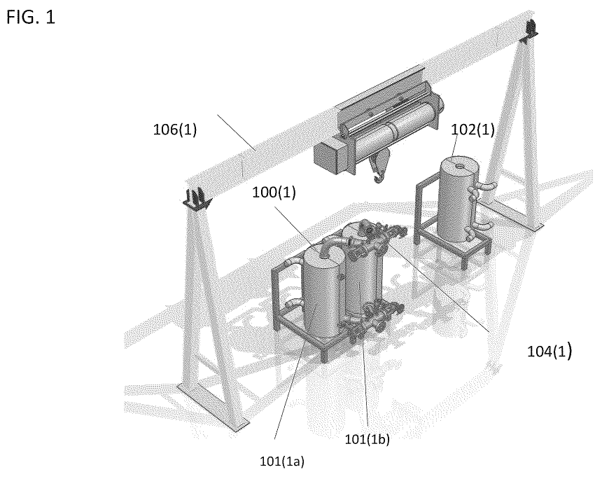

As noted above, FIGS. 1-3 include arrangements that can allow for loading and unloading filter media in a filtration system.

Each system includes a duplex filtration system 100(1)-100(3), that respectively, and an additional warming housing 102(1)-102(3). The duplex filtration system 100(1)-100(3) can include 2 housings 101(1a), 101(1b)-101(3a), 101(3b). The cannisters, in operation, house a filter medium. The medium is typically enclosed in a filter cannister. As shown, in the following figures, the medium is shown in a filter cannister 112.

The duplex system has entry points to the process line for two filter housings: inline and standby, that can be switched. In the standby position, the housing is preheated, ready to be put in the system.

The duplex systems can include indicators that show that the inline filter cannister 112 is expended and ready to be switched. A switch mechanism can then be controlled to change which housing is provided liquid (e.g., which is inline and which is on standby).

The switching mechanisms (104(1)-104(3), respectively) can include a 2-way diverter valve (1 inlet, 2 outlets). The switching mechanisms may be free of dead spaces to eliminate any impurities.

In all cases, the duplex systems 100 can include housings which are pressure vessels, containing filter elements in an optimised layout. The duplex systems 100 can be connected to a polymer production via the seamless switching mechanisms 104. The housings 100 can include means for heating the filter media. This can allow for appropriate temperature by dedicated heating mechanisms that open to enable easy removal of the vessel without the need for breaking heating connections or disassembling interconnecting piping. Different examples are shown in the figures.

When cleaned, the filter media can then be returned to the additional warming housing 102(1)-102(3) so that it is in pre-standby position and can be added into the duplex system after the housing has been cleaned. The warming housing enables a cleaned pressure vessel to hold and warm clean filter media so that it can be provided to the standby location (i.e., the canister in the duplex system not being used after it has been cleaned). The pre-standby location (warming housing 102) is accessible to the system lifting device 106 described below to move the pre-heated media (canisters 112) to the standby location quickly and securely. The vessel from the pre-standby station replaces the expended filter vessel after removal from the line).

In the illustrated instances, the system also includes a lifting device 106(1)-106(3), respectively. Each of the housing 101 in the duplex system 100 and the warming housing 102 can be arranged such they can be opened and then the filter media/cannister 112 connected to and moved by the lifting device 106. As shown, the lifting device is an overhead lifting system that includes a frame and optionally, a slidable lifting element such as a hoist/winch.

With more particular reference to FIG. 1, as shown the housings 101/102 are arranged vertically. This can allow for large diameter piping at the outlet (and potentially also at the inlet) of the vessel to optimize rheology and reduce pressure drop over the complete system. One option is that the housings are 2-piece shells, connected with hinges on one side, and connected to the plant heating system with flexible hoses. The filer media/canister can be removed in an upright position from the housing. This may require motion in x- and y-planes and headroom greater than the length of the cannister 112 above the housings.

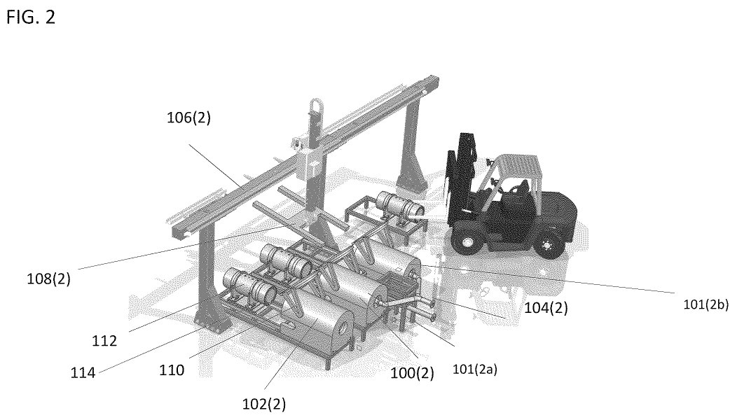

FIG. 2 shows an alternative arrangement. In this arrangement, the duplex system 100 and the warming housing 102 are arranged horizontally. As shown, the housing employ a furnace type heating system. Of course liquid or other media could be used (e.g., as in FIGS. 1/3). It should be noted that while different heating arrangements are shown in different figures, the different methods can be used in any of the configurations shown.

The system in FIG. 2 employs housings that include an entry point in form of a movable door 110. Thus, the lifting device can include an attachment 108(2) that may be used to open up the door 110. The cannisters may be moved in and out of the housings ‘on rails’ 114 for ease of operation. In this embodiment, the filter media/cannisters 112 may be removed from the location in a horizontal orientation requiring less headroom.

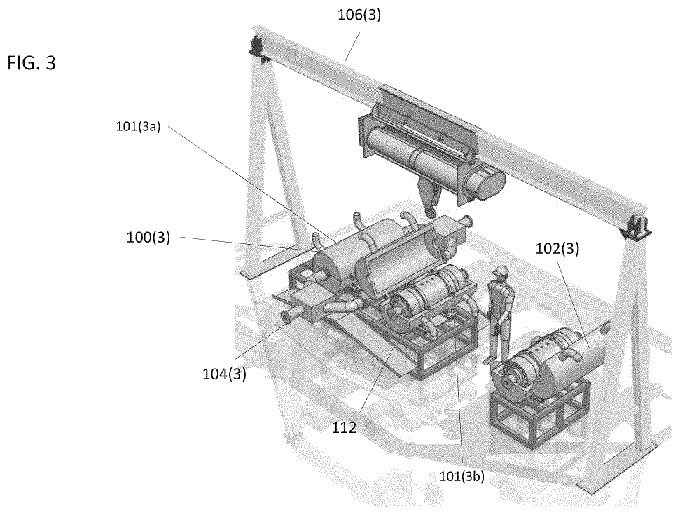

FIG. 3 shown horizontal housings 101/102(3) in the form of 2-piece shells, connected with hinges on one side, that can be connected to the plant heating system with flexible hoses. The filter media 112 can be removed from the location in a horizontal orientation requiring less headroom. In both FIGS. 2 and 3, the media may be rotated to vertical if the filter elements are to be removed immediately.

In the above description, the housings forming the duplex system and the heating housing are all arranged in the same manner. However, in some cases, the housings could be different. For instance, if the housings forming the duplex system are vertical, the heating housing could be either vertical or horizontal. Further, if the housings forming the duplex system are horizontal, the heating housing could be either vertical or horizontal.

Further, while the housings forming the duplex system and the heating housing are shown as similar in each embodiment, the heating housing may not need to be of the same standard or quality as the housings forming the duplex system as it may not have to provide the strict pressures/temperatures that are needed during active filtration.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A filter system comprising:
a duplex filter system that includes a first housing and a second housing configured to filter a liquid;
a heating housing arranged adjacent the duplex filter system; and
a lifting system arranged to move filter canisters from the heating housing to one of the first or second housing.

2. The system of claim 1, wherein the lifting system is arranged to remove filter canisters from the first housing and the second housing.

3. The system of claim 1, wherein the first housing and a second housing are arranged vertically.

4. The system of claim 3, wherein the heating housing is arranged vertically.

5. The system of claim 3, wherein the heating housing is arranged vertically.

6. The system of claim 1, wherein the first housing and a second housing are arranged horizontally.

7. The system of claim 6, wherein the heating housing is arranged vertically.

8. The system of claim 6, wherein the heating housing is arranged vertically.
